(19) United States
(12) Patent Application Publication
(10) Pub. No.: US 2025/0149710 A1
(43) Pub. Date: May 8, 2025

(54) BATTERY MODULE

(71) Applicant: TOYOTA JIDOSHA KABUSHIKI KAISHA, Aichi-ken (JP)

(72) Inventors: Tomoya MESUDA, Nisshin-shi (JP); Seigo FUJISHIMA, Miyoshi-shi (JP); Yoshiro OBAYASHI, Toyota-shi (JP); Kosuke SUZUKI, Toyota-shi (JP); Takeru HARA, Toyota-shi (JP); Satoshi MORIYAMA, Nagoya-shi (JP); Kenta MIYAHARA, Toyohashi-shi (JP)

(21) Appl. No.: 18/929,615

(22) Filed: Oct. 29, 2024

(30) Foreign Application Priority Data
Nov. 6, 2023 (JP) 2023-189545

(51) Int. Cl. H01M 50/242; B60L 50/64; H01M 50/211; H01M 50/682

(52) U.S. Cl. CPC H01M 50/242; B60L 50/64; H01M 50/211; H01M 50/682; H01M 2220/20

(57) ABSTRACT

A battery module includes: a plurality of battery cells, each battery cell being formed by sealing an electrode assembly with a lamination film; and a case capable of housing a battery cell group configured by an array of the plurality of battery cells, wherein a lubricant is provided between the battery cell group and the case.

### CROSS-REFERENCE TO RELATED APPLICATION

This application is based on and claims priority under 35 USC 119 from Japanese Patent Application No. 2023-189545 filed on Nov. 6, 2023, the disclosure of which is incorporated by reference herein.

### BACKGROUND

### Technical Field

The present disclosure relates to a battery module.

### Related Art

The specification of US patent application laid-open 2018/287184 discloses a battery module in which an electrode assembly is housed in a case. Moreover, a structure adopted therein suppresses thermal expansion of the electrode assembly by surrounding an outside of the electrode assembly with a protection layer having thermal contraction properties.

From the perspective of raising a volumetric efficiency of a battery, preferably a battery cell is housed in a case of a battery module without any gap therebetween. However, inserting a battery cell group configured from an array of plural battery cell into a case becomes difficult when there is no leeway between the volume of the case and the volume of the battery cell group.

### SUMMARY

The present disclosure provides a battery module capable of housing a greater amount of battery cell in a case.

A battery module of a first aspect includes a plurality of battery cells, each battery cell being formed by sealing an electrode assembly with a lamination film; and a case capable of housing a battery cell group configured by an array of the plurality of battery cells, wherein a lubricant is provided between the battery cell group and the case.

In the battery module of the first aspect, the battery cell is formed by sealing the electrode assembly with the lamination film, and the case is capable of housing the battery cell group configured by the plural battery cell array. The lubricant is provided between the battery cell group and the case. This means that the frictional resistance when inserting the battery cell group into the case can be reduced by the lubricant.

A battery module of a second aspect is the first aspect, wherein the lubricant is formed containing a material that vaporizes in a particular environment.

In the battery module of the second aspect, after the battery cell group has been inserted into the case, the lubricant is vaporized by placement in the particular environment, enabling the battery cell group to be suppressed from coming out from the case.

A battery module of a third aspect is the first aspect, wherein the lubricant is formed containing a material that increase resistance force to the battery cell coming out from the case in a particular environment.

In the battery module of the third aspect, after the battery cell group has been inserted into the case, the resistance force to the battery cell coming out from the case is increased by placement in the particular environment, enabling the battery cell group to be suppressed from coming out from the case.

A battery module of a fourth aspect is the third aspect, wherein the lubricant is a solid and is formed containing a material having a friction coefficient that increases in a particular environment.

In the battery module of the fourth aspect, the friction coefficient of the lubricant increases by placement in the particular environment, enabling the battery cell group to be suppressed from coming out from the case.

A battery module of a fifth aspect is the third aspect, wherein the lubricant is formed containing a material that increases in volume in a particular environment.

In the battery module of the fifth aspect, the volume of the lubricant is increased in the particular environment, thereby enabling the battery cell group to be suppressed from coming out from the case.

A battery module of a sixth aspect is any one of the second aspect to the fifth aspect, wherein the particular environment is a reduced pressure environment of reduced pressure compared to atmospheric pressure.

In the battery module according to the sixth aspect, the battery cell group can be suppressed from coming out from the case merely by reducing the pressure after housing the battery cell group in the case.

A battery module of a seventh aspect is any one of the second aspect to the fifth aspect, wherein the particular environment is a high temperature environment of a specific temperature or greater.

In the battery module of the seventh aspect, the battery cell group can be suppressed from coming out from the case merely by placement in a high temperature environment after housing the battery cell group in the case.

A battery module of an eighth aspect is the first aspect, wherein the battery cell group is configured including a shock absorption plate provided at an array direction outside of battery cells disposed outermost among the plurality of arrayed battery cells; and the lubricant is provided between the shock absorption plate and the case.

In the battery module of the eighth aspect, the shock absorption plate is provided at both ends of the battery cell group, and so this enables the surface pressure acting on the battery cells to be regulated.

As described above, the battery module according to the present disclosure enables a greater amount of battery cell to be housed in a case.

### BRIEF DESCRIPTION OF THE DRAWINGS

Exemplary embodiments of the present disclosure will be described in detail based on the following figures, wherein:

FIG. 1 is a schematic plan view illustrating relevant portions of a vehicle applied with a battery pack according to a first exemplary embodiment;

FIG. 2 is a schematic perspective view of a battery module;

FIG. 3 is a plan view of a state in which a lid of a battery module has been removed;

FIG. 4 is a schematic illustration of a battery cell housed in a battery module, as viewed along a battery cell thickness direction;

FIG. 5 is a plan view cross-section schematically illustrating a state in which a battery cell group has been inserted into a case in a first exemplary embodiment;

FIG. 6 is a plan view cross-section schematically illustrating a state in which a battery cell group has been inserted into a case in a second exemplary embodiment; and

FIG. 7 is a plan view cross-section schematically illustrating a state in which a battery cell group has been inserted into a case in a third exemplary embodiment.

### DETAILED DESCRIPTION

### First Exemplary Embodiment

Description follows regarding a battery module 11 according to a first exemplary embodiment, with reference to the drawings.

### Vehicle 100 Overall Configuration

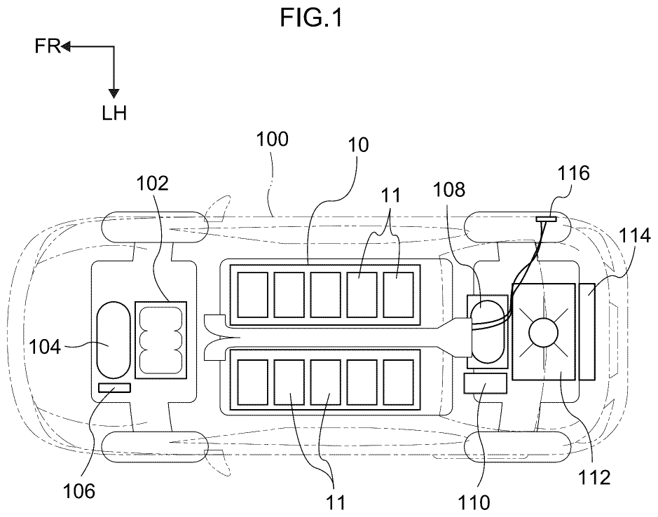

FIG. 1 is a schematic plan view illustrating relevant portions of a vehicle 100 applied with a battery pack 10 according to the present exemplary embodiment. As illustrated in FIG. 1, the vehicle 100 is a battery electric vehicle (BEV) with the battery pack 10 installed below the floor thereof. Note that arrow UP, arrow FR, and arrow LH in each of the drawings indicate, respectively, upward in a vehicle height direction, forward in a vehicle front-rear direction, and leftward in a vehicle width direction. Unless explicitly stated otherwise, directions of front and rear, left and right, and up and down as used in the following explanation respectively indicate front and rear in a vehicle front-rear direction, left and right in a vehicle width direction, and up and down in a vehicle height direction.

As an example of the vehicle 100 of the present exemplary embodiment, a DC/DC converter 102, an electric compressor 104, and a positive temperature coefficient (PTC) heater 106 are disposed further toward the vehicle front side than the battery pack 10. A motor 108, a gear box 110, an inverter 112, and a charger 114 are disposed further toward the vehicle rear side than the battery pack 10.

Direct current output from the battery pack 10 is regulated in voltage by the DC/DC converter 102, and then supplied to the electric compressor 104, the PTC heater 106, the inverter 112, and the like. Rear wheels are rotated by power being supplied to the motor 108 through the inverter 112 to cause the vehicle 100 to travel.

A charging port 116 is provided at a right side portion of a rear section of the vehicle 100, and power from the charging port 116 can accumulate in the battery pack 10 through the onboard charger 114 by being connected to a charging plug of a non-illustrated external charging facility.

Note that the placement, structure, and the like of each component configuring the vehicle 100 are not limited to the configuration described above. For example, application may be made to a hybrid vehicle (HV), or to a plug-in hybrid electric vehicle (PHEV), installed with an engine. Moreover, although the present exemplary embodiment is for a rear-wheel drive vehicle in which the motor 108 is installed to a rear section of the vehicle, there is no limitation thereto, and application may be made to a front-wheel drive vehicle in which the motor 108 is installed to a front section of the vehicle, or a pair of the motors 108 may be installed at the front and rear of the vehicle. Furthermore, application may be made to a vehicle including an in-wheel motor for each wheel.

The battery pack 10 in this case is configured including plural battery modules 11. As an example, in the present exemplary embodiment there are ten of the battery modules 11 provided. Specifically, five of the battery modules 11 are arrayed in the vehicle front-rear direction along the right side of the vehicle 100, and five of the battery modules 11 are arrayed in the vehicle front-rear direction along the left side of the vehicle 100. The respective battery modules 11 are connected together electrically.

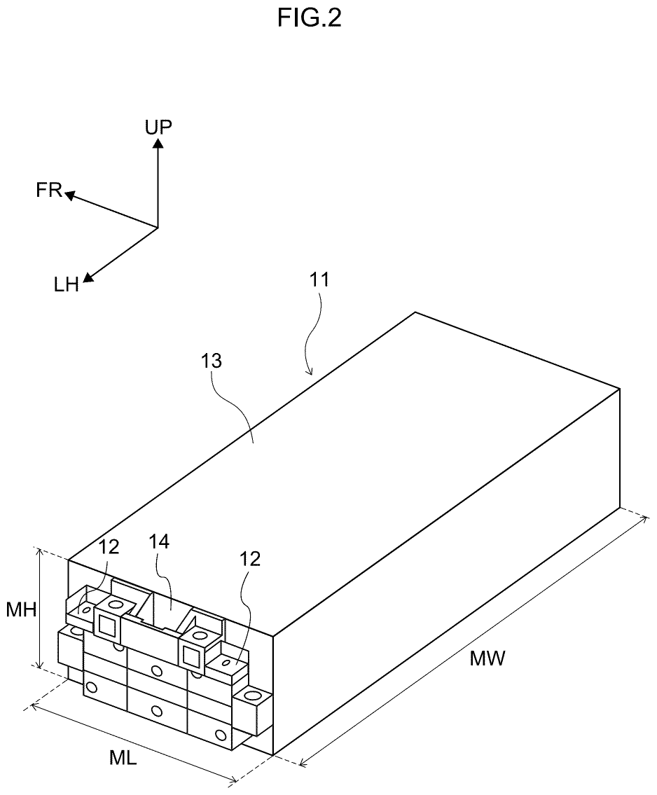

FIG. 2 is a schematic perspective view of the battery module 11. As illustrated in FIG. 2, the battery module 11 is formed in a substantially cuboidal shape having a length direction along the vehicle width direction. A case 13 of the battery module 11 is formed from an aluminum alloy. For example, the case 13 of the battery module 11 is formed by joining die-cast aluminum to both end portions of an extruded member made from aluminum alloy using laser welding or the like.

A pair of voltage terminals 12 and a connector 14 are respectively provided at each of the two vehicle width direction end portions of the battery module 11. A flexible printed circuit (FPC) 21, described later, is connected to the connector 14. A non-illustrated busbar is welded to each of the two vehicle width direction end portions of the battery module 11.

A vehicle width direction length MW of the battery module 11 is, for example, from 350 mm to 600 mm, a vehicle front-rear direction length ML is, for example, from 150 mm to 250 mm, and a vehicle height direction height MH is, for example, from 80 mm to 110 mm.

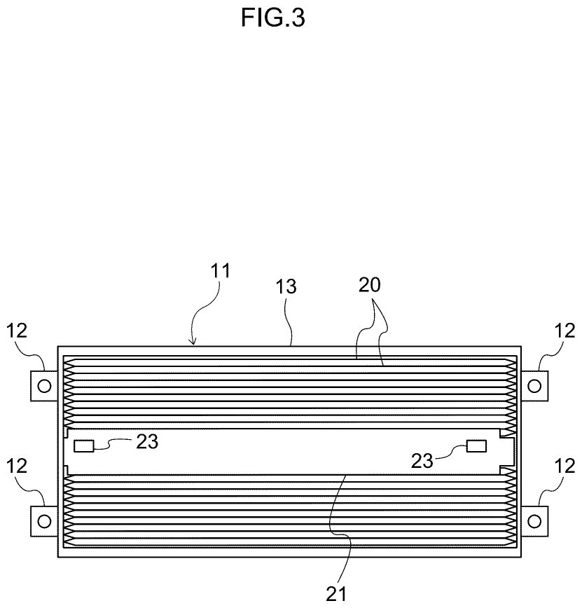

FIG. 3 is a plan view of a state in which a lid of the battery module 11 has been removed. As illustrated in FIG. 3, plural battery cells 20 are housed in an arrayed state in the interior of the battery module 11. As an example of the present exemplary embodiment, 24 of the battery cells 20 are arrayed along the vehicle front-rear direction and adhered to each other.

The flexible printed circuit 21 is disposed above the battery cells 20. The flexible printed circuit 21 is formed in a band shape having a length direction along the vehicle width direction, with a thermistor 23 provided at each of the two end portions of the flexible printed circuit 21. The thermistors 23 are not adhered to the battery cells 20, and are configured so as to be pressed toward the battery cell 20 side by the lid of the battery module 11.

Moreover, one or plural pieces of non-illustrated shock absorption plate is/are housed inside the battery module 11. For example, the shock absorption plate may be a thin sheet shaped member capable of elastic deformation and having a thickness direction along the array direction of the battery cells 20, with the shock absorption plate disposed between adjacent of the battery cells 20. As an example of the present exemplary embodiment, respective pieces of shock absorption plate are disposed at the two length direction end portions of the battery module 11, and at a length direction central portion thereof.

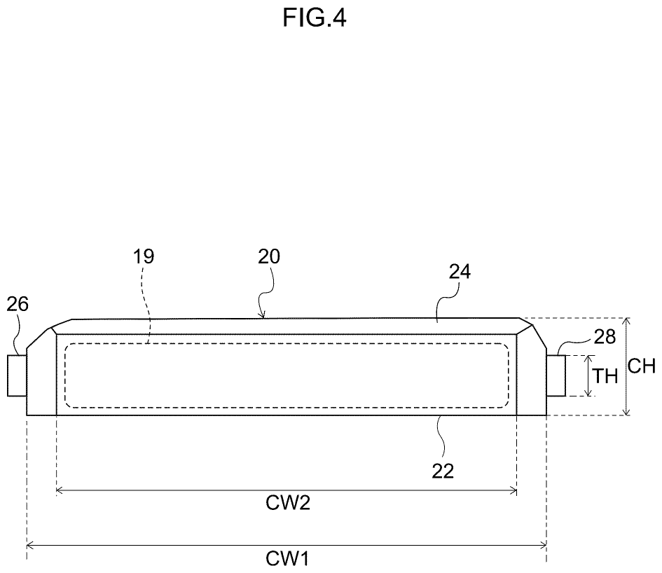

FIG. 4 is a schematic diagram of the battery cell 20 housed in the battery module 11, viewed along the thickness direction of the battery cell 20. As illustrated in FIG. 4, the battery cell 20 is formed in a substantially rectangular plate shape, and an elongated shaped electrode assembly 19 is housed in the interior thereof. The electrode assembly 19 is configured by a lamination of a cathode, an anode, and a separator, sealed by a lamination film 22.

As an example of the present exemplary embodiment, a housing section of the electrode assembly 19 is formed by folding and sticking the lamination film 22 that has an embossed sheet shape. Note that although both a single cup embossed structure embossed in one location, and a double cup embossed structure embossed in two locations, may be adopted, the present exemplary embodiment is a single cup embossed structure having a draw depth of from about 8 mm to about 10 mm.

Upper ends at the two length direction end portions of the battery cell 20 are bent over in an angular external profile. Moreover, an upper end portion of each of the battery cells 20 is also bent over, and a fixing tape 24 is wound along the length direction of the upper end portion of each of the battery cells 20.

Respective terminals (tabs) 26 are provided at the two length direction end portions of the battery cell 20. As an example of the present exemplary embodiment, the terminals 26 are provided at positions offset downward from a height direction center of the battery cell 20. The terminals 26 are joined to the respective non-illustrated busbars by laser welding or the like.

A vehicle width direction length CW1 of each of the battery cells 20 is, for example, from 530 mm to 600 mm, a length CW2 of a region where the electrode assembly 19 is housed is, for example, from 500 mm to 520 mm, and a height CH of the battery cell 20 is, for example, from 80 mm to 110 mm. This means that the battery cell 20 is formed in an elongated shape, with the length CW1 and CW2 directions being length directions.

Moreover, a thickness of each of the battery cells 20 is from 7.0 mm to 9.0 mm, and the height TH of the terminals 26 is from 40 mm to 50 mm.

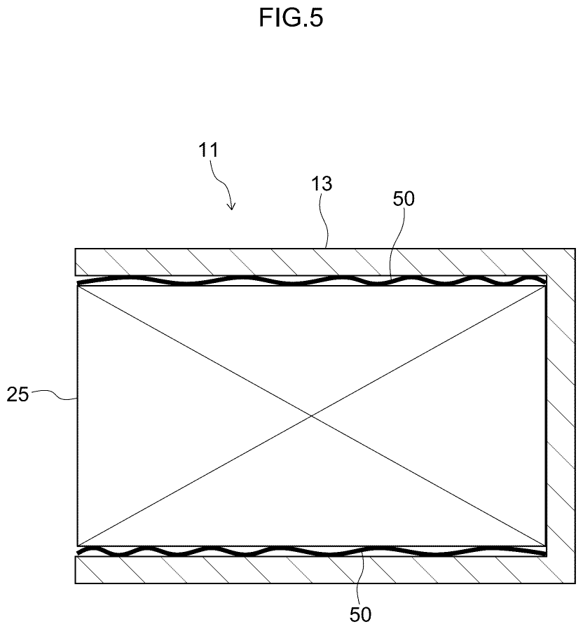

FIG. 5 is a plan view cross-section schematically illustrating a state in which a battery cell group 25 has been inserted into the case 13 of the battery module 11 in the present exemplary embodiment. Note that to simplify explanation, plural battery cells 20 are depicted as the single battery cell group 25 configured from 24 individual battery cells 20 arrayed along the vehicle front-rear direction and adhered together.

As illustrated in FIG. 5, lubricant 50 is provided between the battery cell group 25 and the case 13. As an example in the present exemplary embodiment the lubricant 50 is configured including a lubrication oil that vaporizes in a reduced pressure environment. In other words, the lubricant 50 is configured including a material that increases a resistance force to the battery cell group 25 coming out from the case 13 in a particular environment. Note that reference here to “lubricant” is not limited to a liquid, and is broadly defined as being any member capable of reducing friction between the battery cell group 25 and the case 13.

Moreover, as an example in the present exemplary embodiment, a shock absorption plate is provided at both array direction end portions of the battery cell group 25, with the lubricant 50 interposed between the shock absorption plates and the case 13.

For example, when manufacturing the battery module 11, first the lubricant 50 is supplied into the case 13. Then in a state in which the inside walls of the case 13 have been coated by the lubricant 50, the battery cell group 25 is inserted into the case 13. The frictional force during insertion is reduced by interposing the lubricant 50 between the shock absorption plates of the battery cell group 25 and the case 13 when this is being performed.

After the battery cell group 25 has been inserted into the case 13, the lubricant 50 is vaporized by reducing the pressure before placing the lid on the case 13, and the battery cell group 25 and the case 13 are fixed by frictional force.

### Operation and Advantageous Effects

Next, description follows regarding operation and advantageous effects of the battery module 11 according to the present exemplary embodiment.

In the battery module 11 according to the present exemplary embodiment, the battery cells 20 are each formed by sealing the electrode assembly 19 with the lamination film 22, and the case 13 capable of housing the battery cell group 25 configured from an array of plural of the battery cells 20. Moreover, the lubricant 50 is provided between the battery cell group 25 and the case 13. This means that when inserting the battery cell group 25 into the case 13, the frictional resistance can be reduced by the lubricant 50.

Moreover, in the present exemplary embodiment, after the battery cell group 25 has been inserted into the case 13, the lubricant 50 is vaporized by placement in a particular environment, thereby enabling the battery cell group 25 to be suppressed from coming out from the case 13. In particular by, as in the present exemplary embodiment, employing the lubricant 50 that vaporizes in a reduced pressure environment, serving as the particular environment, the battery cell group 25 can be suppressed from coming out from the case 13 merely by reducing the pressure after the battery cell group 25 has been inserted into the case 13.

Namely, by placement in a reduced pressure environment after the battery cell group 25 has been inserted into the case 13, a resistance force to the battery cells 20 coming out from the case 13 is increased, enabling the battery cell group 25 to be suppressed from coming out from the case 13. As a result thereof, a greater amount of the battery cells 20 is able to be housed in the case 13.

Moreover, in the present exemplary embodiment both ends of the battery cell group 25 are configured by a shock absorption plate, and so this enables surface pressure acting on the battery cells 20 to be regulated.

### Second Exemplary Embodiment

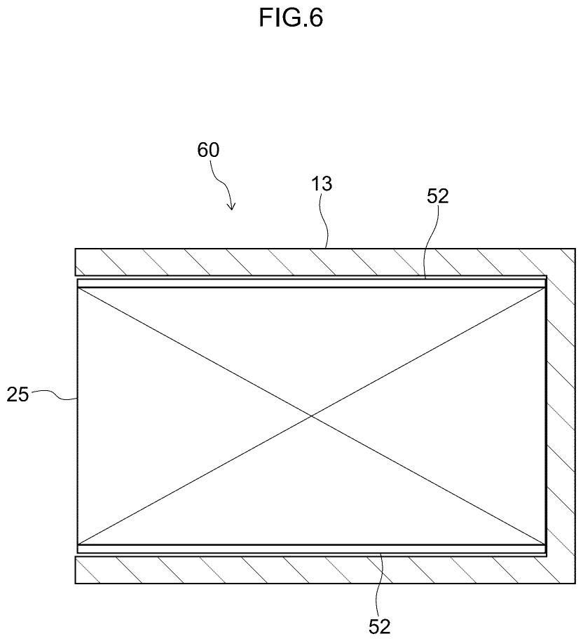

Next, description follows regarding a battery module 60 according to a second exemplary embodiment, with reference to FIG. 6. Note that the same reference numerals will be appended to configuration similar to that of the first exemplary embodiment, and explanation thereof will be omitted as appropriate.

FIG. 6 is a plan view cross-section schematically illustrating a state in which a battery cell group 25 has been inserted into a case 13. As illustrated in FIG. 6, in the present exemplary embodiment a plate shaped lubricant 52 is provided between the battery cell group 25 and the case 13.

The lubricant 52 of the present exemplary embodiment differs from the first exemplary embodiment in being a solid. The lubricant 52 is configured in a plate shape, with both faces thereof having a smaller friction coefficient than the friction coefficient of the battery cell group 25 and the case 13. Namely, the surface of the lubricant 52 has a smaller surface roughness than the battery cell group 25 and the case 13.

Moreover, the lubricant 52 of the present exemplary embodiment is formed including a material that is not vaporized in a reduced pressure environment, and that instead increases in volume under a high temperature environment, thereby increasing the frictional resistance to the battery cell group 25 coming out. In other words, the lubricant 52 is formed including a material having a friction coefficient that increases in a particular environment. Furthermore, the lubricant 52 is preferably formed from a material that does not readily undergo thermal contraction even when cooled to a normal temperature.

### Operation and Advantageous Effects

Next, description follows regarding operation and advantageous effects of the battery module 60 according to the present exemplary embodiment.

In the battery module 60 according to the present exemplary embodiment, the battery cell group 25 is able to be suppressed from coming out from the case 13 due to the volume of the lubricant 52 increasing merely by placement in a high temperature environment after the battery cell group 25 has been housed in the case 13. Other operation and advantageous effects are similar to the first exemplary embodiment.

### Third Exemplary Embodiment

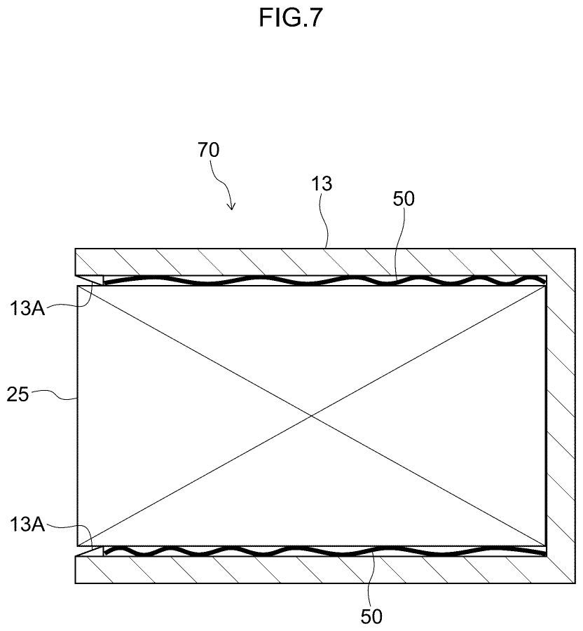

Next, description follows regarding a battery module 70 according to a third exemplary embodiment, with reference to FIG. 7. Note that the same reference numerals will be appended to configuration similar to that of the first exemplary embodiment, and explanation thereof will be omitted as appropriate.

FIG. 7 is a plan view cross-section schematically illustrating a state in which a battery cell group 25 has been inserted into a case 13. As illustrated in FIG. 7, in the present exemplary embodiment, lubricant 50 similar to that of the first exemplary embodiment is provided between the battery cell group 25 and the case 13.

Moreover, anchor claws 13A are provided to inside walls of an opening portion of the case 13 so as to project out in mutually opposing directions. The anchor claws 13A are each equipped with an inclined face that is inclined such that a projection amount increases on progression toward the far side from the opening of the case 13. This means that when inserting the battery cell group 25 into the case 13, a resistance from the anchor claws 13A acting on the battery cell group 25 is not large due to the battery cell group 25 being inserted along the inclined faces of the anchor claws 13A. In contrast thereto, the frictional force from the anchor claws 13A that acts on the battery cell group 25 is comparatively large when moving the battery cell group 25 from the inserted state in a direction to come out, increasing the resistance force against the battery cell group 25 coming out.

### Operation and Advantageous Effects

Next, description follows regarding operation and advantageous effects of the battery module 70 according to the present exemplary embodiment.

In the battery module 70 according to the present exemplary embodiment, the battery cell group 25 can be suppressed from coming out from the case 13 while raising the insertability of the battery cell group 25 through using the lubricant 50.

Moreover, the lubricant 50 can be suppressed from leaking outside from the case 13 by adopting a structure in which a gap between the case 13 and the battery cell group 25 is sealed by the anchor claws 13A. Namely, there is no longer a need to vaporize the lubricant 50. Other operation and advantageous effects are similar to those of the first exemplary embodiment.

Although a description has been given regarding battery modules 11, 60, 70 according to the exemplary embodiments, there is no limitation thereto, and obviously various embodiments may be implemented within a range not departing from the spirit of the present disclosure. For example, as a lubricant a material may be employed that has a friction coefficient that is increased by an increase in viscosity in a particular environment. Moreover, in cases in which the lubricant is a solid such as a shock absorption plate, a material may be employed having a friction coefficient that increases due to surface roughness becoming rougher in a particular environment.

Moreover, as in the particular environment, a lubricant may be employed that contains a material that increases a resistance force to coming out of the battery cell in conditions such as elapse of a specific period of time or greater.

The following supplements are disclosed in relation to the above exemplary embodiments.

### Supplement 1

A battery module including:
a battery cell formed by sealing an electrode assembly with a lamination film; and
a case capable of housing a battery cell group configured by an array of plural of the battery cells, wherein
a lubricant is provided between the battery cell group and the case.

### Supplement 2

The battery module of Supplement 1, wherein the lubricant is formed containing a material that vaporizes in a particular environment.

### Supplement 3

The battery module of Supplement 1, wherein the lubricant is formed containing a material that increase resistance force to the battery cell coming out from the case in a particular environment.

### Supplement 4

The battery module of Supplement 3, wherein the lubricant is a solid and is formed containing a material having a friction coefficient that increases in a particular environment.

### Supplement 5

The battery module of Supplement 3, wherein the lubricant is formed containing a material that increases in volume in a particular environment.

### Supplement 6

The battery module of any one of Supplement 2 to Supplement 5, wherein the particular environment is a reduced pressure environment of reduced pressure compared to atmospheric pressure.

### Supplement 7

The battery module of any one of Supplement 2 to Supplement 5, wherein the particular environment is a high temperature environment of a specific temperature or greater.

### Supplement 8

The battery module of any one of Supplement 1 to Supplement 7, wherein:
the battery cell group is configured including a shock absorption plate provided at an array direction outside of the battery cells disposed outermost from out of the plural arrayed battery cells; and
a lubricant is provided between the shock absorption plate and the case.

What is claimed is:

1. A battery module comprising:
a plurality of battery cells, each battery cell being formed by sealing an electrode assembly with a lamination film; and
a case capable of housing a battery cell group configured by an array of the plurality of battery cells,
wherein a lubricant is provided between the battery cell group and the case.

2. The battery module of claim 1, wherein the lubricant is formed containing a material that vaporizes in a particular environment.

3. The battery module of claim 1, wherein the lubricant is formed containing a material that increase resistance force to the battery cell coming out from the case in a particular environment.

4. The battery module of claim 3, wherein the lubricant is a solid and is formed containing a material having a friction coefficient that increases in a particular environment.

5. The battery module of claim 3, wherein the lubricant is formed containing a material that increases in volume in a particular environment.

6. The battery module of claim 2, wherein the particular environment is a reduced pressure environment of reduced pressure compared to atmospheric pressure.

7. The battery module of claim 2, wherein the particular environment is a high temperature environment of a specific temperature or greater.

8. The battery module of claim 1, wherein:
the battery cell group is configured including a shock absorption plate provided at an array direction outside of battery cells disposed outermost among the plurality of arrayed battery cells; and
the lubricant is provided between the shock absorption plate and the case.

9. The battery module of claim 1, wherein anchor claws are provided at inside walls of an opening portion of the case so as to project out in mutually opposing directions.
